(19) United States
(12) Patent Application Publication
(10) Pub. No.: US 2006/0065609 A1
(43) Pub. Date: Mar. 30, 2006

(54) Fluid control device

(76) Inventor: David Jay Arthur, High Point, NC (US)

Correspondence Address: BRINKS HOFER GILSON & LIONE, P.O. BOX 10395, CHICAGO, IL, 60610, US

(21) Appl. No.: 10/954,706

(22) Filed: Sep. 30, 2004

(51) Int. Cl. C02F 1/38

(52) U.S. Cl. 210/787; 210/799; 210/512.1; 210/513

(57) ABSTRACT

A fluid control device includes an elongated member adapted to be disposed along an axial length of a separator element. The elongated member includes an interior and an exterior. The elongated member also includes a flow outlet disposed at one end. A plurality of annular flow inlets are disposed in the elongated member and adapted to guide fluid flow from a radial direction in the exterior of the elongated member to an axial direction in the interior of the elongated member.

### BACKGROUND

Separator/coalescer units may be used to remove water from a non-aqueous fluid. In one type of separator/coalescer, the separator is a cylindrical element disposed around the vessel outlet. The separator includes a hydrophobic media which is intended to filter out water. The conventional configuration for a separator locates the outlet area at the extreme end of the separator element. This creates a problem because the unrestrictive hydrophobic media typical of a separator does not provide enough resistance to generate uniform flow along the length of the element. Consequently, the majority of the fluid is drawn from the area in the immediate vicinity of the outlet, which causes the section of the element closest to the outlet to be overloaded with flow. This is detrimental to the performance of a separator due to the hydrophobic nature of the media. The higher velocities overcome the hydrophobic properties of the media and force water through the media and into the effluent stream. A previous method for addressing this problem involved decreasing the effective open area of the separator center support tube to make it more restrictive. However, this approach significantly increases the pressure loss across the element. These pressure losses are a result of the fluid being accelerated radially inward before being turned to flow axially down the element to the outlet.

### SUMMARY

In one aspect, a fluid control device includes an elongated member adapted to be disposed along an axial length of a separator element. The elongated member includes an interior and an exterior. The elongated member also includes a flow outlet disposed at one end. A plurality of annular flow inlets are disposed in the elongated member and adapted to guide fluid flow from a radial direction in the exterior of the elongated member to an axial direction in the interior of the elongated member.

In another aspect, a fluid control device includes a first cylindrical element comprising an inner diameter, an inner surface, a first end, and a second end. The first end defines a fluid flow outlet. A second cylindrical element includes an inner diameter, an outer diameter, an inner surface, an outer surface, a first end, and a second end. The first end of the second cylindrical element is disposed adjacent the second end of the first cylindrical element. The inner diameter of the first cylindrical element is larger than the outer diameter of the second cylindrical element. The second end of the first cylindrical element is circumferentially outwardly flared. A first fluid flow inlet is defined in part by the inner surface of the first cylindrical element and the outer surface of the second cylindrical element. A second fluid flow inlet is defined in part by the second end of the second cylindrical element.

The foregoing paragraphs have been provided by way of general introduction, and are not intended to limit the scope of the following claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows a partial cutaway view of one embodiment of a fluid control device in a separator.

FIG. 2 is a perspective view of an embodiment of a fluid control device.

FIG. 3 is a cross sectional view along line 3-3 of FIG. 2.

FIG. 4 is a bottom view of an embodiment of a fluid control device.

FIG. 5 is a perspective view of another embodiment of a fluid control device.

FIG. 6 shows the velocity profile generated by computational fluid dynamics software for a separator without a fluid control device according to the present invention.

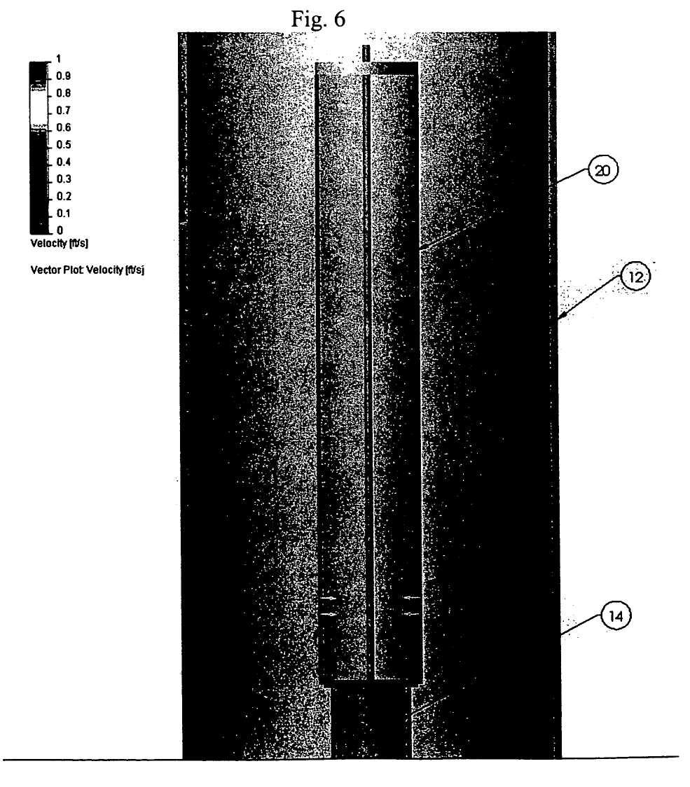

FIG. 7 shows the velocity profile generated by computational fluid dynamics software for a separator with a fluid control device according to the present invention.

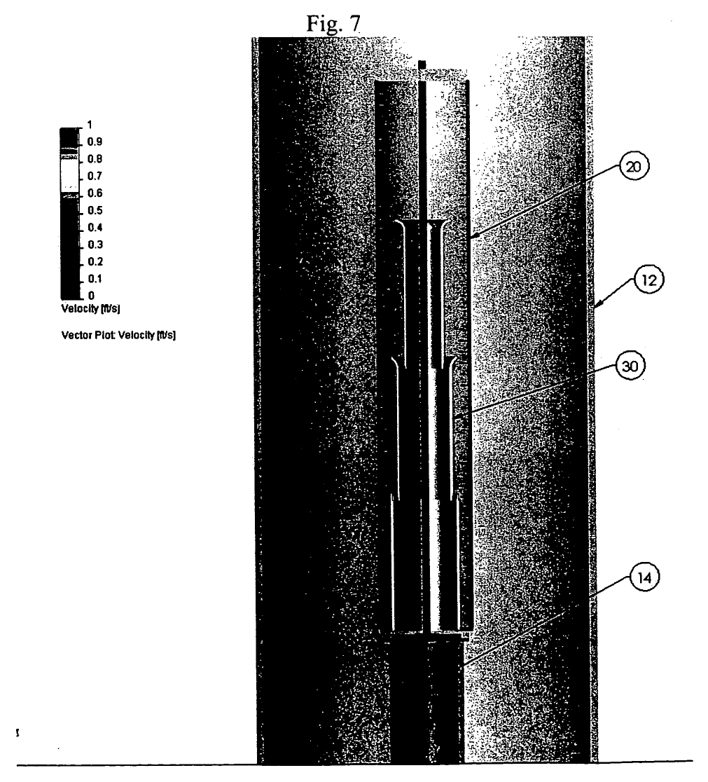

### DETAILED DESCRIPTION

The invention is described with reference to the drawings. The relationship and functioning of the various elements of this invention are better understood by the following detailed description. However, the embodiments of this invention as described below are by way of example only, and the invention is not limited to the embodiments illustrated in the drawings.

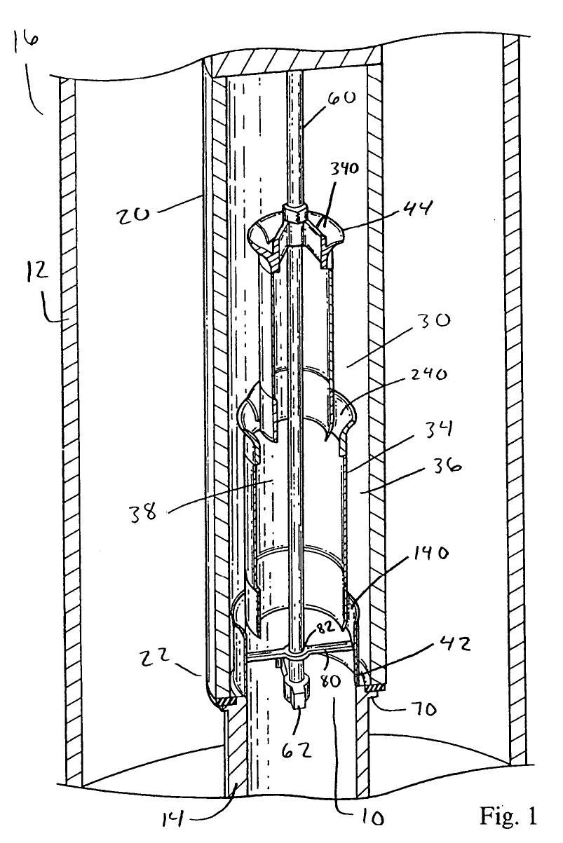

FIG. 1 shows a vessel 16 including a separator element 20. The vessel 16 has a vessel housing 12 with an outlet pipe 14. Disposed inside the vessel 16 is a cylindrical separator element 20. Disposed within the separator element 20 is a fluid control device 30. To exit through the outlet pipe 14, a fluid in the vessel 16 must pass through the separator element 20 and the fluid control device 30. In one embodiment, the vessel 16 contains a nonaqueous fluid, and the separator element 20 is made of a hydrophobic media designed to separate water out of the nonaqueous fluid.

In one embodiment, the fluid control device 30 is used to create a more uniform velocity profile along the length of a relatively unrestrictive filtration element such as that of a separator in a coalescer/separator device. A uniform velocity profile is believed to improve the liquid/liquid separation ability of a separator element. High peak velocities are reduced and smoothed out to more effectively utilize the entire length of the separator. In one embodiment, the improved separation is achieved by dividing the single large flow area normally located at the extreme end of a separator element 20 into three, four, or any plurality of smaller flow areas distributed along the element's length.

Referring now to FIGS. 1-3, in one embodiment, the fluid control device 30 includes an elongated member 34 disposed along the axial length of a separator element 20. The elongated member 34 includes a first end 42 and a second end 44. The flow outlet 10 of the fluid control device 30 is disposed at the first end 42 of the elongated member 34. Annular flow inlets 140, 240, and 340 are provided on the elongated member 34. Although three annular flow inlets 140, 240, and 340 are shown in FIG. 1, the elongated member 34 may include fewer or more flow inlets. The annular flow inlets 140, 240, and 340 are adapted to guide fluid flow from a radial direction in the exterior 36 of the elongated member 34 to an axial direction in the interior 38 of the elongated member 34. Fluid flows radially inward through the separator element 20 and through the annular flow inlets 140, 240, and 340. As the fluid flows through the annular flow inlets, it turns from a radial direction toward an axial direction, and then flows out through the outlet 10.

The fluid control device includes at least two cylindrical elements. A first cylindrical element 100 has an inner diameter 102, an inner surface 110, a first end 106, and a second end 108. The first end 106 includes a fluid flow outlet 10. A second cylindrical element 200 includes an inner diameter 202, an outer diameter 204, an inner surface 210, an outer surface 230, a first end 206, and a second end 208. The first end 206 of the second cylindrical element 200 is disposed adjacent the second end 108 of the first cylindrical element 100. The inner diameter 102 of the first cylindrical element 100 is larger than the outer diameter 204 of the second cylindrical element 200. The second end 108 of the first cylindrical element 100 includes a circumferentially outwardly flared portion 120. A fluid flow inlet 140 is defined in part by the inner surface 112 of the outwardly flared portion 120 and the outer surface 232 of the second cylindrical element 200. A second fluid flow inlet 240 is defined in part by the second end 208 of the second cylindrical element 200.

As shown in FIG. 1, in one embodiment, a rod 60 projects up from a support member 62 on the cartridge stool 70. The cartridge stool 70 is part of the vessel 16 and provides a surface that seals against the end 22 of the separator element 20. The rod 60 is axially disposed through the fluid control device 30. A support member 80 with a hole 82 is provided on the rod 60. The support member 80 extends from the rod 60 to the inner surface of the first cylindrical element 100. The support member 80 keeps the fluid control device aligned on the cartridge stool 70, with the rod 60 running through the center of the fluid control device 30.

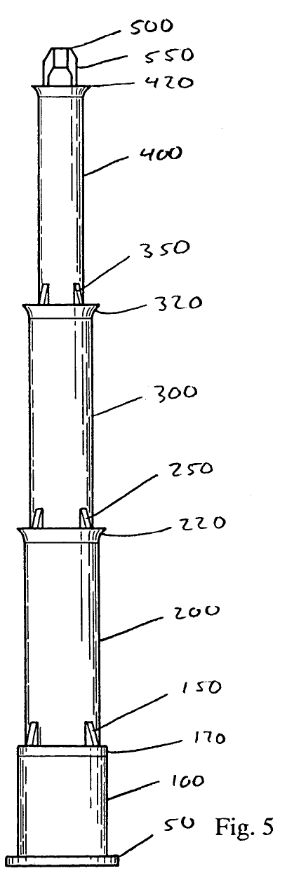

In another embodiment, shown in FIG. 5, a mounting flange 50 serves as a base for the fluid control device 30. The mounting flange 50 secures the first cylindrical element 100 to the vessel housing 12. Attached to the mounting flange 50 is the first cylindrical element 100. In one embodiment, a holddown button 500 and support members 550 keep the fluid control device 30 centered on the cartridge stool.

As shown in FIGS. 1-3, in one embodiment, the fluid control device includes a hole 82 in the support member 80 and another centered hole 602 in the top member 600. The fluid control device 30 may be installed by aligning these holes with the rod 60 and sliding the fluid control device 30 down the rod 60 until it seats on the cartridge stool 70. A nut 610 is threaded down the end of the rod 60 to fasten the fluid control device 30 in place. The separator 20 is then slid down around the fluid control device 30 and seated on the cartridge stool 70.

In another embodiment, the fluid control device 30 includes a third cylindrical element 300. The first end 306 of the third cylindrical element 300 is disposed adjacent the second end 208 of the first cylindrical element 200. The inner diameter 202 of the second cylindrical element 200 is larger than the outer diameter 304 of the third cylindrical element 300. The second end 208 of the second cylindrical element 200 includes a circumferentially outwardly flared portion 220. A fluid flow inlet 240 is defined in part by the inner surface 212 of the outwardly flared portion 220 and the outer surface 332 of the third cylindrical element 360. Another fluid flow inlet 340 is defined in part by the inner surface 312 of the outwardly flared portion 320 and the outer surface 604 of the top member 600.

As shown in FIG. 5, in another embodiment, the device includes a fourth cylindrical element 400. The fluid control device may have additional cylindrical elements, with each cylindrical element having a smaller outside diameter than the inner diameter of the preceding cylindrical element. In one embodiment, the cylindrical elements are concentric. Each of the annular flow inlets has a flow area defined by the outer surface of the adjacent cylindrical element and the inner surface of the adjacent outwardly flared end.

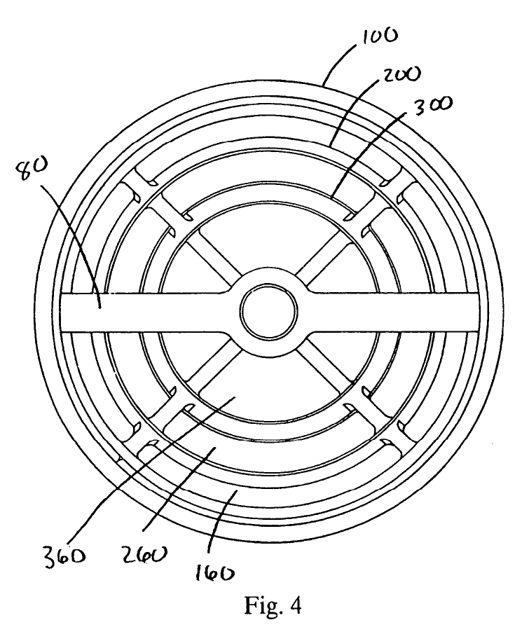

FIG. 4 shows a bottom view of one embodiment of the fluid control device 30. The cylindrical elements define a series of concentric annular flow areas. The flow area 160 is between the first cylindrical element 100 and the second cylindrical element 200. The flow area 260 is between the second cylindrical element 200 and the third cylindrical element 300. The flow area 360 is between the third cylindrical element 300 and the top member 600. In one embodiment, the flow areas get smaller by about 10% as they proceed up the fluid control device 30. Thus, in one embodiment, flow area 160 is the largest, flow area 260 is about 10% smaller than flow area 160 and flow area 360 is about 10% smaller than flow area 260. In another embodiment, each of these flow areas 160, 260, and 360 is substantially equal.

Although the embodiments shown in FIGS. 1-5 include cylindrical elements with circular cross sections, it is apparent that this shape may be varied to include, for example, elliptical cross sections and any other shaped cross section that would produce the desired flow characteristics.

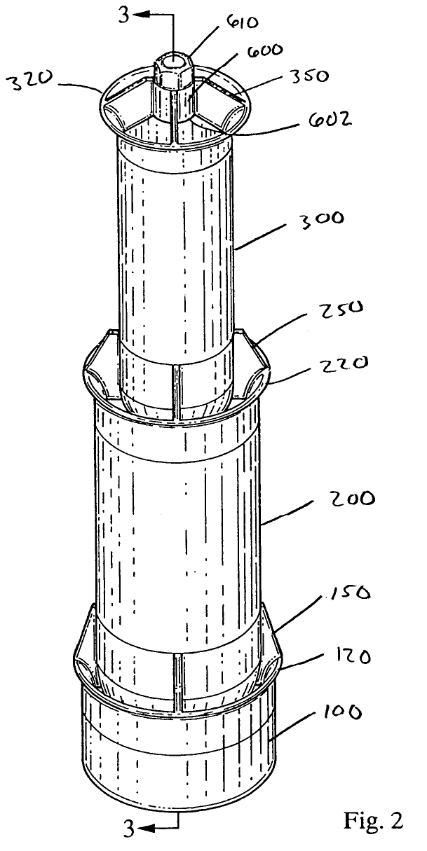

In one embodiment, support members 150 are disposed between the inner surface of the first cylindrical element 100 and the outer surface of the second cylindrical element 200, as best seen in FIG. 2. The support members 150 support the second cylindrical element 200. Similarly, where the fluid control device 30 has additional cylindrical elements, support members 250 and 350 may be disposed between the second 200 and third 300 cylindrical elements and the third 300 and fourth 400 cylindrical elements, respectively. In one embodiment, the support members 150 are thin tapering fins. The thin tapering shape helps to minimize the disruption to the fluid flow. In one embodiment, the fluid control device 30 has four support members disposed between adjacent cylindrical elements.

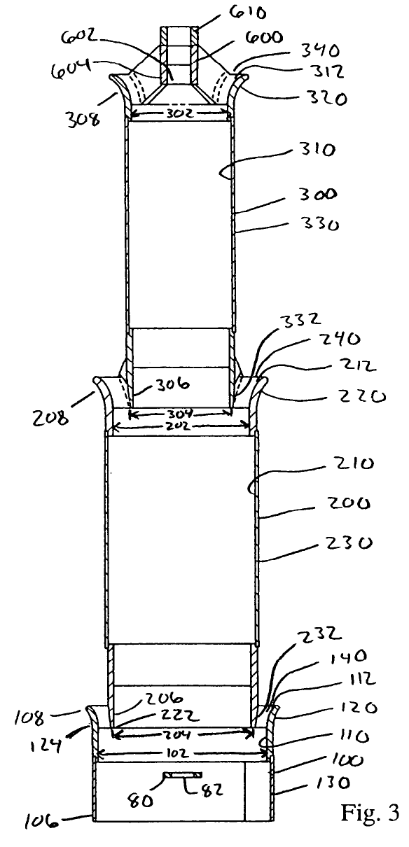

In one embodiment, shown in FIG. 3, the circumferentially outwardly flared portion 120 of the first cylindrical element 100 has an outwardly curving inner surface 112. In other embodiments, the flared portions 220, 330, and 440 of the second, third, and fourth cylindrical elements 200, 300, 400 have outwardly curving inner surfaces. In one embodiment, the radius of the outwardly curving inner surface is proportional to the inside diameter of the flow area. The radius may be defined by Rᵢ=C*Dᵢ, where R is the radius of the flare, C is a constant between about 0.2 and about 0.3, and D is the inside diameter of that particular flow opening.

In one embodiment, the outer surface 232 of the first end 206 of the second cylindrical element 200 is beveled, as shown in FIG. 3. The outer surface 232 of the wall of the second cylindrical element 200 tapers inwardly to reduce the wall thickness at the first end 206. The beveling reduces the amount of flow area that is blocked due to the wall thickness of the second cylindrical element 200. Similarly, the first end 306 of the third cylindrical element 300 may be beveled.

In one embodiment, the first end 206 of the second cylindrical element overlaps slightly with the second end 108 of the first cylindrical element, as shown in FIG. 3. In one embodiment, the end surface 222 of the first end 206 of the second cylindrical element 200 is disposed generally at the point 124 where the interior surface 110 of the second end 108 of the first cylindrical element 100 begins its outward curvature. Similarly, in other embodiments, the first end of each cylindrical element overlaps slightly with the second end of the adjacent cylindrical element, and the first end of each cylindrical element is disposed generally at the point where the interior surface of the second end of the adjacent cylindrical element begins its outward curvature.

The sizes of the various elements depend on the size of the separator element 20 and the desired flow characteristics. In one embodiment, the inner diameter 202 of second cylindrical element 200 is about 85-90% of the inner diameter 102 of the first cylindrical element 100. In another embodiment, the inner diameter 302 of third cylindrical element 300 is about 75-85% of the inner diameter 202 of the second cylindrical element 200. In one embodiment, the lengths of the second 200 and third 300 cylindrical elements are about equal, and about twice the length of the first cylindrical element 100. Many variations of lengths and diameters are possible and the invention is not limited to the specific dimensions disclosed herein.

The elements of the fluid control device 30 may be made of any material suitable for the intended working environment. In one embodiment, the elements are made of steel. In another embodiment, the elements are made of aluminum. The fluid control device may have a single piece construction or may be multiple elements which are connected together.

### EXAMPLE 1

FIG. 4 shows the velocity profile generated by computational fluid dynamics software for a separator without a fluid control device. The length of the arrows corresponds to the velocity of the fluid. In FIG. 4, it can be seen that the fluid velocity at the bottom end of the separator is much larger than at the top end, and that a majority of the fluid flow is at a very narrow length of the bottom end of the separator. The higher velocities can overcome the hydrophobic properties of the media and force water through the media and into the effluent stream. FIG. 5 shows the velocity profile generated by computational fluid dynamics software for a separator with a fluid control device. In FIG. 5 it can be seen that the fluid flow is relatively even along a majority of the length of the separator. This creates a more even flow distribution of water droplets and improves the efficiency of the separator at removing water.

### EXAMPLE 2

A coalescer/separator unit with and without a fluid control device according to the present invention was tested according to API 1581 5th Edition Specification and Qualification Procedures for Aviation Jet Fuel Filter/Separators (July 2002), the contents of which are herein incorporated by reference. Each test used a horizontal vessel equipped with 10 coalescers and three separators. One test was performed using a standard separator, the other used fluid control devices according to the present invention in each separator. The testing is designed to measure the capability of a separator to remove water from jet fuel. The test, as described in section 4.4.5 in the Specification and Qualification Procedures for Aviation Jet Fuel Filter/Separators, consisted of five steps: media migration, water coalescence at 0.01% water addition, solids holding, a second 0.01% water addition, and 3% water addition. The maximum value that is acceptable for the testing procedure is 15 ppm water in the effluent.

The first phase of the test was media migration. This phase is designed to condition the coalescer elements. No water or dirt was added during this phase. A sample was taken at the end to look for media migration downstream. This phase lasted 30 minutes.

The second phase of the test was the water coalescence at 0.01% water addition. This is designed to give an indication of the performance of the coalescer/separator with clean elements. Water concentration readings were taken at 5, 10, 20, and 30 minutes and a Stop/Start (S/S) procedure was performed at 15 minutes and 30 minutes. The S/S procedure is designed to simulate the stopping and starting of fuel flow during a refueling process. The results of this phase are shown in Table 1. It can be seen that using the fluid control device according to the present invention resulted in a lower water concentration in the effluent than a separator without a fluid control device. The fluid control device according to the present invention was able to achieve water concentrations of 1 ppm or less. Additionally, the pressure drop with the fluid control device according to the present invention was only slightly higher than without the fluid control device.

TABLE 1
Second Phase: Water Coalescence at 0.01% Addition

| | | Standard | | Flow control | |
|---|---|---|---|---|---|
| | | Separator | | device | |
| | Fuel Flow | | Water | | Water |
| Time | Rate | ΔP | Conc. | ΔP | Conc. |
| (min) | (gpm) | (psi) | (ppm) | (psi) | (ppm) |
| 0 | 1543 | 5.8 | — | 6.0 | — |
| 5 | 1543 | 5.9 | 1.0 | 6.2 | 0.5 |
| 10 | 1543 | 6.1 | — | 6.4 | 1.0 |
| 15 s/s | 1543 | 6.3 | 1.0 | 6.5 | |
| 20 | 1543 | 6.5 | 1.5 | 6.7 | 1.0 |
| 30 | 1543 | 6.7 | 3.0 | 7.2 | 1.0 |
| 30 s/s | 1543 | 6.9 | 2.0 | 7.2 | |

The third phase of the test was the solids addition. In this phase, a test dust was injected into the incoming fuel stream to contaminate the coalescers. No water was added during this phase and water concentration readings were not taken.

The fourth phase was a second 0.01% water addition. This is designed to give an indication of the performance of the coalescer/separator after having been exposed to solid contaminants. Water concentration readings were taken at 0, 2, 5, 15, 30, 45, 60, 75, and 90 minutes. Stop/start procedures were performed at the 30, 60, and 90 minute marks. The results of this phase are shown in Table 2. It can be seen that using the fluid control device according to the present invention results in a lower water concentration in the effluent than a separator without a fluid control device. The fluid control device according to the present invention was able to achieve water concentrations of less than 5 ppm. Additionally, the pressure drop with the fluid control device according to the present invention was only slightly higher than without the fluid control device.

TABLE 2
Fourth Phase: 0.01% Water Addition

| | | Standard | | Flow control | |
|---|---|---|---|---|---|
| | | Separator | | device | |
| | Fuel Flow | | Water | | Water |
| Time | Rate | ΔP | Conc. | ΔP | Conc. |
| (min) | (gpm) | (psi) | (ppm) | (psi) | (ppm) |
| 0 | 1543 | 8.9 | — | 9.1 | — |
| 2 | 1543 | — | | 9.2 | — |
| 5 | 1543 | 9.2 | | 9.5 | — |
| 15 | 1543 | 10.1 | 6.5 | 10.6 | 1.5 |
| 30 s/s | 1543 | 10.9 | 2.5 | 11.2 | 1.5 |
| 45 | 1543 | 11.4 | 8.0 | 11.6 | 1.5 |
| 60 s/s | 1543 | 11.9 | 2.5 | 11.9 | 4.5 |
| 75 | 1543 | 12.0 | 13.0 | 12.1 | 2.0 |
| 90 s/s | 1543 | 12.3 | 6.0 | 12.3 | 2.5 |

The final phase increased the water injection rate to 3%. The results of this phase are shown in Table 3. The water concentration in the standard separator went offscale at two minutes, meaning it was greater than the maximum instrument value, and the test was stopped. The fluid control device according to the present invention was able to achieve water concentrations of less than 5 ppm. Additionally, the pressure drop with the fluid control device according to the present invention was only slightly higher than without the fluid control device.

TABLE 3
Fifth Phase: 3% Water Addition

| | | Standard | | Flow control | |
|---|---|---|---|---|---|
| | | Separator | | device | |
| | Fuel Flow | | Water | | Water |
| Time | Rate | ΔP | Conc. | ΔP | Conc. |
| (min) | (gpm) | (psi) | (ppm) | (psi) | (ppm) |
| 0 | 1543 | 12.2 | | 12.4 | — |
| 2 | 1543 | 16.5 | off scale | 17.2 | 2.5 |
| 5 | 1543 | | | 17.8 | 3.0 |
| 10 | 1543 | | | 18.8 | 3.5 |
| 15 | 1543 | | | 19.3 | 3.0 |

From Tables 1, 2, and 3, it can be seen that the fluid control device according to the present invention results in a lower water concentration in the effluent than a separator without a fluid control device. The fluid control device according to the present invention was able to achieve water concentrations at each phase of less than 5 ppm. Additionally, the pressure drop with the fluid control device according to the present invention is only slightly higher than without the fluid control device.

The embodiments described above and shown herein are illustrative and not restrictive. The scope of the invention is indicated by the claims rather than by the foregoing description and attached drawings. The invention may be embodied in other specific forms without departing from the spirit of the invention.

What is claimed is:

1. A fluid control device comprising:
an elongated member adapted to be disposed along an axial length of a separator element, the elongated member comprising an interior, an exterior, a first end, and a second end;
a flow outlet disposed at the first end of the elongated member; and
a plurality of annular flow inlets disposed in the elongated member and adapted to guide fluid flow from a radial direction in the exterior of the elongated member to an axial direction in the interior of the elongated member.

2. The fluid control device of claim 1 wherein the plurality of annular flow inlets comprises two flow inlets.

3. The fluid control device of claim 1 wherein the plurality of annular flow inlets comprises three flow inlets.

4. The device of claim 1 wherein the separator element has an inner surface and the radial velocity of a fluid flowing through the separator element is substantially uniform across a majority of the inner surface of the separator element.

5. The fluid control device of claim 1 wherein the plurality of annular flow inlets are concentric.

6. The fluid control device of claim 1 wherein the plurality of annular flow inlets are each defined by an inner wall and an outer wall.

7. The fluid control device of claim 6 wherein the inner wall is cylindrical and the outer wall is outwardly curved.

8. The fluid control device of claim 7 wherein each annular flow inlet has a flow area defined by the corresponding inner cylindrical wall and outer outwardly curved wall, and wherein the flow areas of the plurality of annular flow inlets are substantially equal.

9. A fluid control device comprising:
a first cylindrical element comprising an inner diameter, an inner surface, a first end, and a second end, wherein the first end defines a fluid flow outlet;
a second cylindrical element comprising an inner diameter, an outer diameter, an inner surface, an outer surface, a first end, and a second end, wherein the first end of the second cylindrical element is disposed adjacent the second end of the first cylindrical element, and wherein the inner diameter of the first cylindrical element is larger than the outer diameter of the second cylindrical element;
wherein the second end of the first cylindrical element is circumferentially outwardly flared, and wherein a first fluid flow inlet is defined in part by the inner surface of the first cylindrical element and the outer surface of the second cylindrical element and a second fluid flow inlet is defined in part by the second end of the second cylindrical element.

10. The device of claim 9 further comprising a third cylindrical element comprising an inner diameter, an outer diameter, an inner surface, an outer surface, a first end, and a second end, wherein the first end of the third cylindrical element is disposed adjacent the second end of the second cylindrical element, and wherein the inner diameter of the second cylindrical element is larger than the outer diameter of the third cylindrical element;
wherein the second end of the second cylindrical element is circumferentially outwardly flared, and wherein the second fluid flow inlet is defined in part by the inner surface of the second cylindrical element and the outer surface of the third cylindrical element

11. The device of claim 10 further comprising a fourth cylindrical element comprising an inner diameter, an outer diameter, an inner surface, an outer surface, a first end, and a second end, wherein the first end of the fourth cylindrical element is disposed adjacent the second end of the third cylindrical element, and wherein the inner diameter of the third cylindrical element is larger than the outer diameter of the fourth cylindrical element;
wherein the second end of the third cylindrical element is circumferentially outwardly flared, and wherein a third fluid flow inlet is defined in part by the inner surface of the third cylindrical element and the outer surface of the fourth cylindrical element.

12. The device of claim 9 wherein the first and second cylindrical elements are disposed within a separator element.

13. The device of claim 12 wherein the separator element comprises a hydrophobic media.

14. The device of claim 9 further comprising a plurality of support members between the inner surface of the first cylindrical element and the outer surface of the second cylindrical element.

15. The device of claim 10 further comprising a plurality of support members between the inner surface of the second cylindrical element and the outer surface of the third cylindrical element.

16. The device of claim 11 further comprising a plurality of support members between the inner surface of the third cylindrical element and the outer surface of the fourth cylindrical element.

17. The device of claim 9 wherein the circumferentially outwardly flared second end of the first cylindrical element has an inner surface, and the inner surface curves outwardly.

18. The device of claim 9 wherein the outer surface of the first end of the second cylindrical element is beveled.

19. The device of claim 9 further comprising a mounting flange securing the first cylindrical element to a vessel housing.

20. The device of claim 9 further comprising a rod axially disposed through the fluid control device and a support member extending from the rod to the inner surface of the first cylindrical element.

21. The device of claim 12 wherein the separator element has an inner surface and the radial velocity of a fluid flowing through the separator element is substantially uniform across a majority of the inner surface of the separator element.

22. A coalescer comprising the device of claim 13 capable of achieving less than 5 ppm water in the effluent in the fourth stage of API 1581 Fifth Edition qualification.

23. A coalescer comprising the device of claim 13 capable of achieving less than 5 ppm water in the effluent in the fifth stage of API 1581 Fifth Edition qualification.

24. A method for controlling the velocity profile in a fluid permeable cylindrical separator comprising a flow outlet and disposed in a vessel, the method comprising:
providing a generally cylindrical elongated member between the separator and the flow outlet;
providing between the separator and the flow outlet a plurality of annular fluid inlets distributed along the length of the generally cylindrical elongated member;
introducing a fluid into the vessel; and
guiding the fluid from a radial direction to an axial direction.

25. The method of claim 24 wherein the separator element comprises a hydrophobic media.

26. The method of claim 24 wherein the separator element has an inner surface and the radial velocity of a fluid flowing through the separator element is substantially uniform across a majority of the inner surface of the separator element.

27. The method of claim 25 further comprising achieving less than 5 ppm water in the effluent in the fourth stage of API 1581 Fifth Edition qualification.

28. The method of claim 25 further comprising achieving less than 5 ppm water in the effluent in the fifth stage of API 1581 Fifth Edition qualification.
